(19) United States
(12) Patent Application Publication
(10) Pub. No.: US 2020/0024044 A1
(43) Pub. Date: Jan. 23, 2020

(54) BIODEGRADABLE NATURAL PLASTIC CONTAINER

(71) Applicant: Monica Elizabeth WRIGHT, Falls Church, VA (US)

(72) Inventor: Monica Elizabeth WRIGHT, Falls Church, VA (US)

(21) Appl. No.: 16/512,516

(22) Filed: Jul. 16, 2019

Related U.S. Application Data
(60) Provisional application No. 62/699,879, filed on Jul. 18, 2018.

(51) Int. Cl. B65D 65/46; B29D 22/00; B65D 75/20; B65D 75/58; A23L 33/00; C08B 31/00; C08K 5/09; C08K 5/092; C08K 5/053; C08L 3/02

(52) U.S. Cl. CPC B65D 65/463; B29D 22/003; B65D 65/466; B65D 75/20; B65D 75/5811; A23L 33/40; C08K 2201/014; C08K 5/09; C08K 5/092; C08K 5/053; C08L 3/02; A23V 2002/00; C08L 2201/06; C08B 31/00

(57) ABSTRACT

A biodegradable container made from plant-based plastic that holds, in a preferred embodiment, one to two ounces of a gel-like or otherwise viscous liquid for immediate nutrition. Once opened and used, the container can be safely disposed of on the ground where it will be broken down by natural factors like rain over several days.

This application claims the benefit of U.S. Provisional Patent Application No. 62/699,879 filed Jul. 18, 2018, the entire contents of which are hereby incorporated by reference.

### BACKGROUND OF THE INVENTION

### Field of Invention

The invention relates to the field of packaging and in a particular embodiment, to packaging for small portion or single serving sports nutrition supplements for sustained athletic activity.

It has long been customary to utilize various types of flexible sheet material containers for protectively packaging commodities of any types. The use of such flexible containers for liquids, gels, condiments, etc. is presently limited. Although these items may be neatly contained in such flexible containers, difficulties are encountered with regard to proper disposal of torn off tops for the containers as well as the containers themselves.

For example, energy gels are currently very popular, used predominantly by serious endurance athletes during long races or training sessions. Such energy gels generally contain a large amount of carbohydrate-based calories contained within a small container. However, such gel packets have historically had a similar design in that when opening the container, the top is completely separated from the container, and disposal of both the top and container body become problematic, especially since the athletes may be otherwise actively engaged. Unfortunately, it is often the case that the separated tops (and sometimes the containers themselves) end up being thrown onto trails or roads where they may remain over long periods of time unless physically picked up and removed.

Syrups and squeezable gels used by consumers today include Clif Shot® gel, GU Roctane Ultra Endurance Energy® gel, Powerbar® gel, and Powerbar® gel Blasts®. Gels are typically available in 1 to 2 ounce single-serve packs, particularly for use among athletes. Existing packaging for commercially available gels is made from some combination of foil and plastic. Brands like Clif® have addressed the issue of safe waste disposal through a design for a “litter leash,” which consolidates the container into one piece, even after it has been opened and used. Clif® also offers a recycling program for their food and gel packaging, but to the best of my knowledge, there is no brand or company today that offers a completely biodegradable container.

### BRIEF SUMMARY OF THE INVENTION

This invention relates to a biodegradable container made of natural materials. In one non-limiting embodiment, the invention may be used in the context of single-use sports nutrition supplements. The structure of the closed container may comprise a smooth, sealed edge that terminates in a laterally-extending, wedge-shaped integral tab indicating where it can be torn open.

In one exemplary embodiment, a flexible and semi-transparent sheet of bioplastic material is laser-cut or die-cut into the preferred shape. To form the material into a container, the flat sheet is folded lengthwise and sealed shut with the same material used to form the flat sheet applied to the edges. The edges are pressed together and left to dry until the edges are relatively rigid and dry to the touch. In the preferred embodiment, the semi-open container is then injected with a sports nutrition supplement and then fully sealed in the same manner previously described.

The invention also relates to a method of forming a biodegradable container as described in detail below.

### BRIEF DESCRIPTION OF THE DRAWINGS

FIG. 1 is a perspective view of a biodegradable natural plastic container in its filled state in accordance with an exemplary but non-limiting embodiment of the invention;

FIG. 2 is a side elevation of the container shown in FIG. 1; and

FIG. 3 is a front elevation view of the flat sheet that forms the container shown in FIG. 1

### DETAILED DESCRIPTION OF THE DRAWINGS

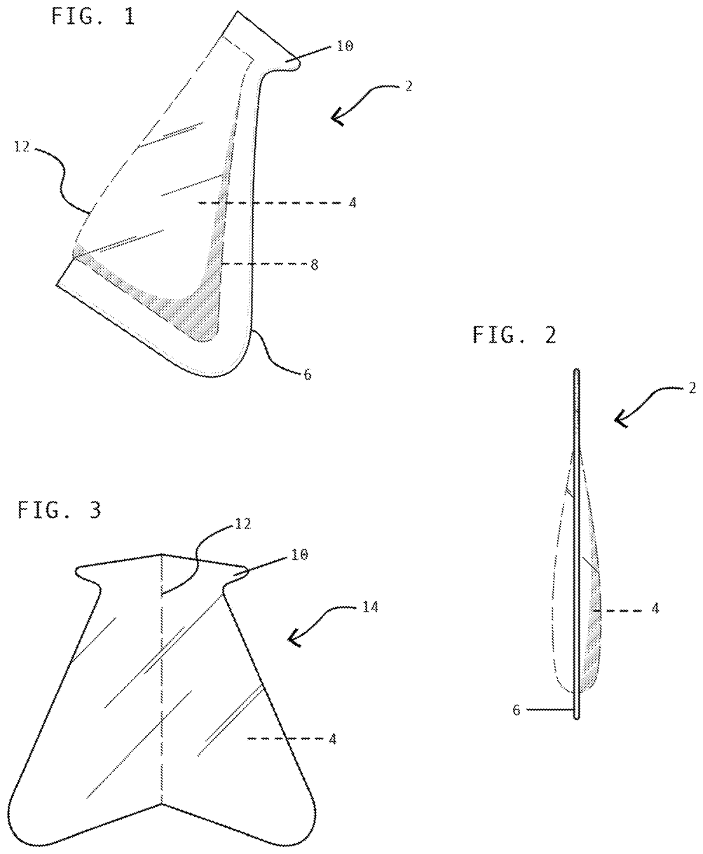

FIG. 1 shows a biodegradable container 2 in accordance with a non-limiting embodiment. The entire container is made from one material with no additional parts. The structure of the closed container 2 is formed from a flat sheet 14 folded in half about the line of symmetry 12 and formed with a smooth outer or peripheral edge 6 that may or may not indicate the marginal seam 8 where the container is sealed shut. In the illustrated embodiment, container 2 is filled, either with a sports nutrition supplement or other viscous or gel-like fluid. When filled, the container 2 may bulge or otherwise subtly change shape along folded edge 12 as shown in FIG. 1 and/or in the center cavity or pocket 4 as shown in FIG. 2. The container 2 is tapered toward the top or opening end, forming a substantially truncated triangular shape, with a wedge-shaped, integral tab 10 extending laterally beyond the tapered upper end of the container. The tab 10 may be grasped by the user to facilitate tearing open the upper end of the container. The tapered end of the container and wedge shape of the tab 10 provides sufficient space adjacent the tab to hold the container while tearing the tab to access the contents. The wedge shape at the top of the container also serves as a visual cue for where the container may be opened.

In one non-limiting example, the exterior surface of one or both sides of the container may be etched or otherwise imprinted with text or images to illustrate brand name, contents, etc. In the preferred embodiment, the container material is substantially transparent to a degree that allows a view of the interior of the container, but it will be appreciated that the container may be substantially opaque. The outer edge 6 of the container may be fully rigid or somewhat flexible and may vary in width.

In one exemplary embodiment, the composition of the mixture used to make the sheets 14 of the container 2 comprises 73.2% to 77.4% water, fruit juice, vegetable juice, or any combination thereof; 7.7% to 9.2% starch derived from any combination of corn, potato, tapioca, wheat, rice, or equivalents; 3.0% to 4.6% acetic acid from a source such as white vinegar mixed with 7.7% to 9.2% citric acid such as lemon juice for a combined percentage which should be proportioned to the amount of starch at a ratio of 4:3; 1.9% to 2.3% agarose and agaropectin mixture; and 1.3% to 1.5% plant-based glycerin. In the preferred embodiment the composition of the container should also include 1.1% collagen and less than 0.1% thyme oil. The sheet 14 may range from 0.2 mm to 0.4 mm in material thickness.

The invention also relates to a method of fabricating a biodegradable container. The method comprises combining the above listed ingredients by stirring together over heat ranging from 160° C. to 195° C. until the mixture begins to gel. Once the mixture begins to gel it should be removed from heat and poured onto a flat sheet of metal or otherwise non-stick material, the size of which should correspond to the volume of the mixture at a ratio of 1 square meter per 140 to 165 fluid ounces. Once the mixture has been poured onto the flat sheet it should be stored in a room or enclosure with 40-50% humidity. The mixture is fully dry when it can be pulled off the surface of the flat sheet. The mixture should now comprise one flexible and semi-transparent oversized sheet of bioplastic material.

In one and presently preferred embodiment, the oversized flat sheet of bioplastic material should be die-cut or laser-cut into a smaller piece 14. This smaller sheet 14 should be folded along its longitudinal line of symmetry 12 and sealed shut with the same material used to form the large flat sheet. The additional material is applied to the free edges of the sheet and pressed together in a manner similar to glues used for adhering papers, and left to dry until the edge is rigid and dry to the touch. In one and presently preferred embodiment, the semi-open container is injected with a sports nutrition supplement and then fully sealed along its top edge in the same manner previously described. The container material as described herein is fully compatible with energy gels currently available, with no contamination of taste or texture of the gels.

In an exemplary but non-limiting embodiment, the container 2 as described may be used before, during, or after an athletic competition or similarly strenuous physical activity. The user simply grasps the container and tears it from the tab 10 to access the contents. The torn portion may be partially or completely separated from the container body.

There could also be potential for use in settings where there is limited access to fresh food and proper waste disposal, for example at a campsite or another remote location.

It is also to be noted that aside from being biodegradable, the container as described is also edible, assuming precautions are taken regarding the composition of any added printed matter. In this case, simple etching of printed matter on the material is preferred. For example, one may tear off the the tab 10 with one's teeth and eat the torn-off part rather than dispose of it in a normal manner. Though it is not preferred, the entire package can be eaten with no need to tear at tab 10.

It will be appreciated that many modifications and alterations may be made by those having ordinary skill in the art without departing from the spirit and scope of the invention. For example, although a particular shape for the container has been indicated in FIG. 1 and FIG. 2, a container with the same function and material could take a basic geometric shape or other irregular shape entirely, either for the sake of efficiency, production limitations, or for decorative purposes. In addition, it will be appreciated that the described process steps could be automated for large production runs.

Therefore the disclosed embodiment has been set forth only for the purposes of example and should not be taken as limiting the invention as otherwise described and illustrated herein.

1. A container for a nutrition product comprising:
a flexible container body formed at one end with an integral tear-away tab, the container body comprising naturally biodegradable bioplastic material.

2. The container of claim 1 wherein said biodegradable bioplastic material is edible and is made from a composition comprising water and/or juice; starch; acetic acid; citric acid; and plant-based glycerin.

3. The container of claim 1 wherein said biodegradable and edible plastic material is made from a composition comprising at least 73.2-77.4% water, fruit juice, vegetable juice or any combination thereof.

4. The container of claim 3, wherein the composition comprises 7.7-9.2% starch, wherein the starch is selected from the group consisting of corn starch, potato starch, tapioca starch, wheat starch, rice starch, and mixtures thereof.

5. The container of claim 4, wherein the composition comprises 3.0-4.6% acetic acid.

6. The container of claim 5, wherein the composition comprises 7.7-9.2% citric acid.

7. The container of claim 6, wherein the composition comprises 1.3-1.5% plant-based glycerin.

8. The container of claim 7, wherein the composition comprises 1.9-2.3% agarose and agaropectin mixture.

9. The container of claim 8, wherein the composition comprises 1.1% collagen.

10. The container of claim 9, wherein the composition comprises less than 0.1% thyme oil.

11. A one-piece container for a nutrition product comprising a pair of flexible sheets joined about a peripheral edge portion and including an integral tear away tab portion, said flexible sheets comprising a naturally biodegradable, bioplastic material.

12. The container of claim 11, wherein a single sheet of said material is folded over about an axis of symmetry to form said pair of flexible sheets and said peripheral edge portion, said peripheral edge portion sealed by additional amounts of said material.

13. The container of claim 12 comprising a body of a generally truncated triangular shape with a tapered end, said tear-away tab portion comprising a wedge-shaped portion extending beyond said tapered end.

14. The container of claim 11, wherein said naturally biodegradable bioplastic material is edible and is made from a composition comprising water and/or juice; starch; acetic acid; citric acid; plant-based glycerin; agarose and/or agaropectin; collagen; and thyme oil.

15. A method of producing a naturally biodegradable container comprising the steps of creating a bioplastic material by combining and heating a mixture comprising plant-based starch, acetic and/or citric acid, plant-based glycerin, agarose and/or agaropectin until the mixture has increased opacity and/or viscosity.

16. The method of claim 15 comprising pouring the mixture into a mold and drying the mixture in the mold until dry.

17. The method of claim 16, wherein the dried mixture comprises a flat sheet of the bioplastic material, wherein the flat sheet has an average thickness between 0.2 millimeters and 1 millimeter.

18. The method of claim 17 further comprising cutting the bioplastic material into smaller, individual pieces.

19. The method of claim 18, wherein the cutting is achieved via laser or die.

20. The method of claim 19 further comprising etching text and/or imagery into a surface of the bioplastic material via laser or die.
